(19) United States
(12) Patent Application Publication
(10) Pub. No.: US 2005/0200883 A1
(43) Pub. Date: Sep. 15, 2005

(54) Printer and method for configuring the same

(76) Inventor: Michael Mannion, Toronto (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/054,107

(22) Filed: Feb. 9, 2005

Related U.S. Application Data
(60) Provisional application No. 60/546,381, filed on Feb. 20, 2004.

(51) Int. Cl. G06F 15/00

(52) U.S. Cl. 358/1.15

(57) ABSTRACT

A method for configuring a printer comprises printing instructions associated with a set of options on a printer. Input based on the printed instructions is received via an input interface of the printer. The printer is then configured according to the input received. The instructions can correspond to a set of options which are printed with the instructions. The options can correspond to pre-defined settings identified using user-friendly names. In one embodiment, the input is sent to a server that then transmits configuration information to the printer. Upon receipt of the configuration information, the printer configures itself accordingly.

This application claims the benefit of U.S. Provisional Application No. 60/546,381 filed Feb. 20, 2004.

### FIELD OF THE INVENTION

The present invention relates generally to peripheral devices and, more specifically, to a printer and method for configuring the same.

### BACKGROUND OF THE INVENTION

Printers, including single and multi-function printers and other devices with printing capabilities, are being deployed in a widening variety of environments and are being provided with increased functionality in response to consumer needs. The configuration of such printers to customize them for the requirements of particular environments is well understood. Printers typically have a number of user-configurable settings that permit configuration of their functionality. Such user-configurable functionality can include the printing of banner pages for each print job, the powering down of the printer during periods of inactivity, automated pausing of a print job while the output tray is cleared, the print languages used by the printer, etc.

The user-configurable settings also include network settings that can be modified to enable the printers to communicate with other devices over a network in a desired manner. For example, where the printer includes a network interface and is capable of communication over an IP network, the network settings can include the IP address assigned to the printer, the subnet mask of the network to which the printer is connected and the IP address of a gateway for accessing other IP addresses outside the subnet mask. Additionally, where the network interface is capable of connecting to a wireless local area network using IEEE 802.11x technology, the network settings can include the SSID of the printer, the name of a preferred access point and various security settings (such as for WEP or WPA). Further, there can be other settings such as simple network management protocol (“SNMP”) trap settings for automatic notification of printer error states and LPR settings for setting print queue information.

In some cases, printer configuration can be performed using the input interface of the printer. The input interface can include, but is not limited to, a set of buttons, switches, covers and paper trays. Generally, one of the buttons is designated as a menu button that, when depressed, causes a menu to be presented on the display of the printer. Typically, the display of the printer is only capable of presenting a single line of characters, making navigation of the menu cumbersome and confusing. Such limited-sized displays also generally do not permit the presentation of additional information to assist the user when configuring the printer.

Point-of-sale (“POS”) printers generally have a very limited input interface that does not readily permit entry of network settings. The configuration of POS printers is typically performed via a configuration utility program executed on a computer in communication with the POS printer. The utility program allows the user to configure all of the parameters required for communication with and operation of the POS printer. Configuring POS printers using these configuration utility programs can be onerous as they require the user to be computer-literate and have knowledge of network settings. This is beyond the skill set of many point-of-sale system operators.

The configuration of the network settings of a printer can be very confusing to a user that is not technically adept. For example, in an IP network, each device is assigned a unique IP address that is used to identify communications directed to the device. Thus, a printer in an IP network is only identified to other devices, such as terminals, on the network by its IP address. When a printer is disconnected from the network and replaced with another printer, the IP address of the disconnected printer is typically transferred to the replacement printer so that other devices in the network can access the functionality of the printer. Unfortunately, each IP address is a non-intuitive set of four numbers separated by decimals, such as 192.168.0.26, that generally bears no relation to printer location. As a result, the user must search for the IP address assigned to the original printer and manually configure the replacement printer with this IP address. This usually requires the services of a person with special skills to administer these changes. As will be appreciated, there exists a need for a method of configuring printers that is less onerous for a user who is not technically adept.

It is therefore an object of the present invention to provide a novel printer and method for configuring the same.

### SUMMARY OF THE INVENTION

Accordingly, in one aspect of the present invention, there is provided a method for configuring a printer, comprising:
printing instructions on a printer;
receiving input based on the printed instructions via an input interface of said printer; and
configuring said printer using said input.

In a particular aspect, the printer is connected to a network, and the configuring comprises configuring at least one network setting of said printer.

In another particular aspect, the instructions correspond to a set of options. The options can be identified using user-friendly names and can correspond to network configurations. The network configurations can include an IP address. At least one of the network configurations can correspond to an absent printer.

The instructions can include, but are not limited to, one or more interaction methods such as the depression of at least one button and the opening of a cover.

In another aspect of the invention, there is provided a method for configuring a printer using a computing device, comprising:
transmitting instructions to be printed to a printer;
detecting input entered via said printer, said input corresponding to said instructions and being received by said printer via an input interface thereof; and
transmitting configuration information to said printer in accordance with the detected input.

In a further aspect of the invention, there is provided a printer, comprising:
a network interface detecting and establishing communication with a computing device, and receiving instructions associated with a set of options to be printed from said computing device;
a printing module printing said instructions;
an input interface receiving input corresponding to said instructions; and
a processor directing said input to said network interface for transmission to said computing device, and configuring said printing data in response to configuration information received from said computing device.

In a still further aspect of the invention, there is provided a method of enabling communication with a computing device using a printer, comprising:
receiving instructions from a computing device with a printer;
printing said instructions with said printer;
receiving input corresponding to said instructions via an input interface of said printer; and
transmitting said input to said computing device.

In still another aspect of the invention, there is provided a printer, comprising:
a network interface receiving, from a computing device, at least one instruction to be printed;
a printing module printing said at least one instruction; and
an input interface receiving input corresponding to said at least one instruction, wherein said input is transmitted to said computing device via said network interface.

The printer configuration method provides advantages in that a user who is not technically adept can configure the printer as it permits the configuration of settings that are otherwise difficult to configure. By assigning user-friendly names to the stations at which printers are situated, users can more readily identify printers from a list of options. Where a station has recently had a printer removed, a substitute printer can be readily configured. As any options and instructions are printed on pages, other information can be printed to supplement the user-friendly names. In this manner, options can be fully explained to the user.

### BRIEF DESCRIPTION OF THE DRAWINGS

Embodiments will now be described, by way of example only, with reference to the accompanying drawings in which:

FIG. 1 illustrates a POS system;

FIG. 2 is a schematic diagram of a printer forming part of the POS system of FIG. 1;

FIG. 3 is a perspective view of the printer of FIG. 2;

FIG. 4 is a flow chart of a discovery cycle used by a server forming part of the POS system of FIG. 1 to discover the printers in the POS system;

FIG. 5 is a flow chart of a printer processing method performed upon discovery of a printer during the discovery cycle of FIG. 4;

FIG. 6 is a flow chart showing the steps performed to determine whether a discovered printer requires configuration;

FIG. 7 shows the POS system of FIG. 1 after disconnection of a printer;

FIG. 8 shows the POS system of FIG. 1 after a new printer requiring configuration is connected to the POS network;

FIGS. 9A and 9B show a flow chart of the method of determining whether a printer identified as possibly requiring configuration during the method of FIG. 6 actually requires configuration;

FIG. 10 illustrates a printer configuration table;

FIG. 11 is a flow chart of a printer user interface initialization method;

FIG. 12 is a flow chart of a replace routine called during the printer processing method of FIG. 5;

FIG. 13 is a flow chart of a selection process routine called during the replace routine of FIG. 12;

FIG. 14 is a flow chart of an error state routine called during the replace routine of FIG. 12;

FIG. 15 is a flow chart of a confirm routine called during the replace routine of FIG. 12;

FIG. 16 is a flow chart of a get type routine called during the replace and confirm routines of FIGS. 12 and 15 respectively;

FIG. 17 is a flow chart of an ask type routine called during the get type routine of FIG. 16; and

FIG. 18 is a flow chart of an add routine called during the ask type routine of FIG. 17.

### DETAILED DESCRIPTION OF THE EMBODIMENTS

In the following description, a printer and method for configuring the same are provided to overcome disadvantages associated with prior art printer configuration methods and allow configuration of a printer by a user that is not technically adept. During printer configuration, instructions that are printed by the printer are used to configure the printer. The instructions are generally associated with a set of options. To select an option, the user interacts with the input interface of the printer in accordance with the instructions for the desired option. Upon receipt of the user input, the printer is configured in accordance with the user's selection.

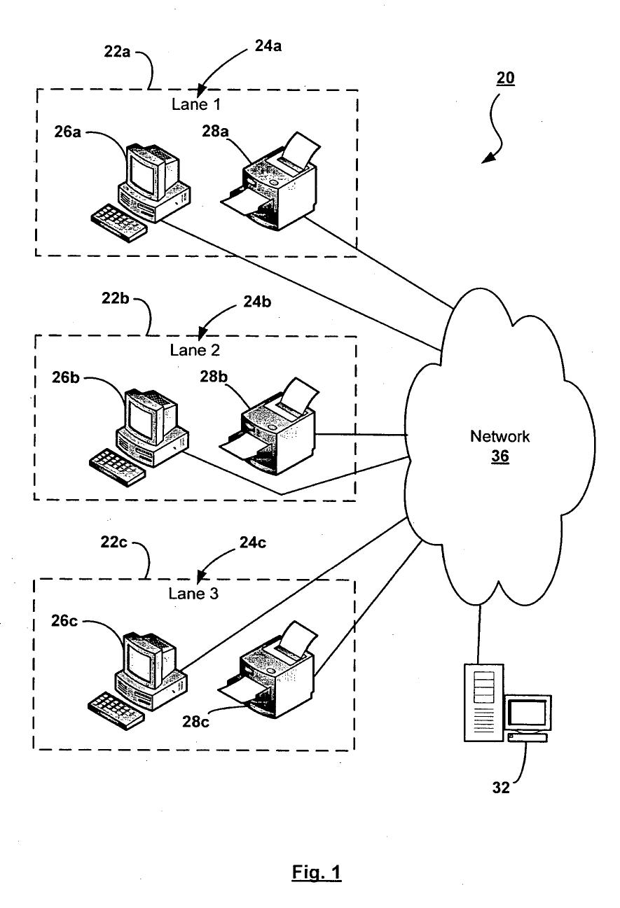

Turning now to FIG. 1, an exemplary point-of-sale (“POS”) system for a retail environment is shown and is generally identified by reference numeral 20. The POS system 20 includes stations 22a, 22b and 22c positioned at the checkout lanes of the retail environment. Each of the stations is assigned a user-friendly name. In this case, station 22a is assigned user-friendly name “Lane 1” 24a, station 22b is assigned user-friendly name “Lane 2” 24b and station 22c is assigned user-friendly name “Lane 3” 24c.

Each station includes a terminal and a printer. Terminal 26a and printer 28a are located at first station 22a. Similarly, terminal 26b and printer 28b are located at second station 22b, and terminal 26c and printer 28c are located at third station 22c. The terminals and printers at the stations 22a to 22c communicate with a server 32 over a communications network 36.

The terminals 26a, 26b and 26c are computing devices that have been adapted to provide retail sales terminal functionality, including the registration of goods being purchased, the tallying of a running total cost of the goods, and the processing of credit or debit card payments. In addition, the terminals 26a, 26b and 26c can generate various print jobs, including a bill for goods and a daily summary.

Each of the terminals 26a, 26b and 26c sends print jobs to its associated printer at the same station. For example, terminal 26a is configured to send print jobs to the printer 28a at station 22a by addressing the print jobs to the IP address of the printer 28a. Terminal 26a is not aware that printer 28a is located at the same station, but has simply been configured to address print jobs to a specific IP address. As a result, care must be taken to ensure that the targeted printer (generally that located at the same station) is configured with the same IP address to which print jobs are addressed by the terminal 26a.

The configuration of each of the printers 28a, 28b and 28c is assigned a user-friendly name. As each of the printers 28a, 28b and 28c is located at a separate station, the user-friendly name is a descriptive name relating to the station at which it is located. Thus, the configuration of the printer 28a has been assigned the name 44a “Lane_1”, the configuration of the printer 28b has been assigned the name 44b “Lane_2”, and the configuration of the printer 28c has been assigned the name 44c “Lane_3”.

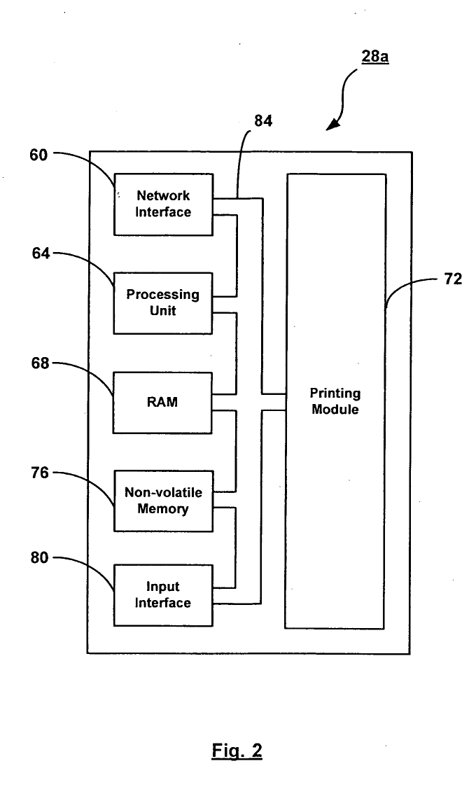

Turning to FIG. 2, one of the printers 28a is illustrated. It will be appreciated that in this example all of the printers are basically the same. The printer 28a is a receipt printer with a configuration feature that facilitates configuration of the printer. As can be seen, the printer 28a comprises a network interface 60, a processing unit 64, random access memory (“RAM”) 68, a printing module 72, non-volatile memory 76 and an input interface 80, all in communication over a local bus 84. All communications with external devices, such as the receipt of print jobs, are directed through the network interface 60. The network interface 60 has a unique Media Access Control (“MAC”) address that identifies communications generated by the printer and is not generally alterable.

The processing unit 64 executes an operating system that enables extended functionality of the printer 28a to be accessed via the ESC/POS protocol. ESC/POS is a powerful, extensible protocol that permits remote printing and enables the transmission of event notifications to a remote computing device.

Configuration information can also be sent and received via the ENPC protocol over UDP/IP. ENPC has the added advantage of being able to receive and respond to UDP broadcast packets to allow detection of a printer with an invalid configuration. In addition, configuration information can be sent to the printer via ESC/POS.

Further, the processing unit 64 executes a network configuration program for reconfiguring the network configuration of the printer 28a. The network configuration program listens for network configuration information incoming via ENPC. Upon receipt of network configuration information, the network configuration program reconfigures the network configuration of the printer accordingly.

The processing unit 64 also coordinates the temporary storage, or buffering, of print jobs in RAM 68 until the printing module 72 is ready to print them. The printing module 72 is operable to print on print media loaded into the printer 28a. Settings for the printer 28a, including network settings, are stored in non-volatile memory 76.

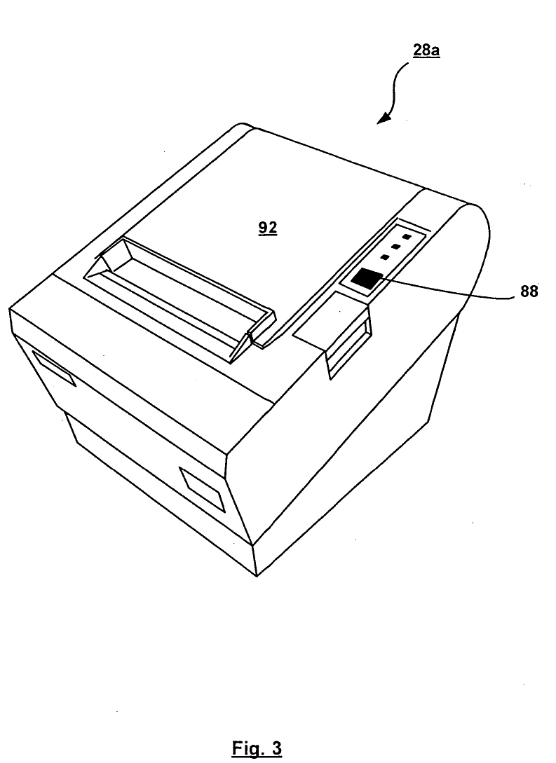

FIG. 3 better illustrates the input interface 80. The input interface 80 is shown having a paper feed button 88 and a cover 92. The paper feed button 88 is used to advance paper from a roll of paper accommodated by the printer 28a. The cover 92 provides access to the roll of paper for replacement and paper jam clearing.

When a printer such as printer 28a is added to the communications network 36, the server 32 discovers the printer, determines whether the printer requires configuration and executes a configuration procedure if the printer requires configuration.

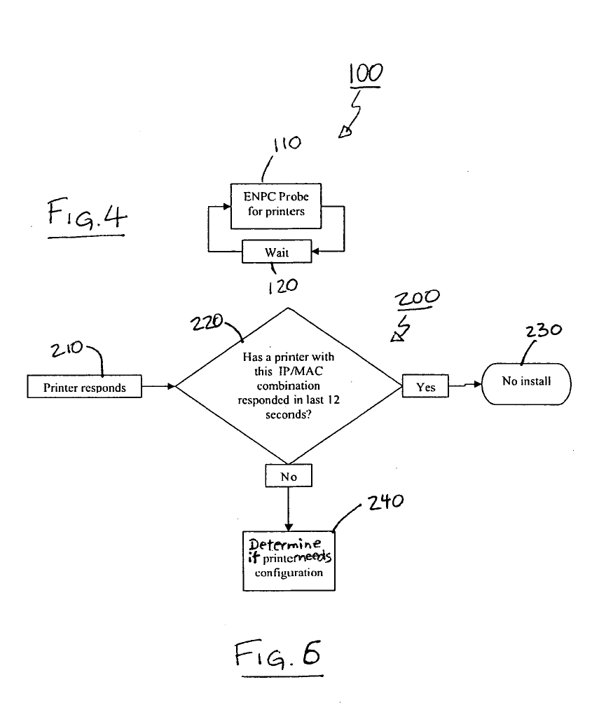

FIG. 4 illustrates a discovery cycle 100 that the server 32 executes in order to discover and register printers connected to the communications network 36. The server 32 broadcasts a discovery probe message over the ENPC protocol (step 110) and then waits a time period of five seconds before returning to step 110 to repeat the discovery cycle 100 (step 120). All printers connected to the communications network 36 are conditioned to respond to discovery probe messages and, as a result, the server 32 receives responses from both newly-connected printers and from printers connected to the network for longer periods of time. As the responses from the printers are received by the server 32, the printers are selectively queued in a first-in-first-out buffer for possible configuration.

FIG. 5 shows the general method 150 of processing each printer in the queue. Each printer's response to the discovery probe message is analyzed to determine whether the printer requires configuration (step 160). During analysis of the printer's response at step 160, it is determined whether the printer responded to a recent discovery probe message with the same IP address that it currently is using. If the printer did, the printer is deemed to not require configuration. Otherwise, the printer is flagged as possibly requiring configuration and the printer's configuration is further analyzed. During further analysis, the current printer configuration is verified using a printer configuration database. If the verification of the current printer configuration fails, the printer configuration is updated accordingly. If the printer does not require configuration, the method 150 ends. If the printer requires configuration, the user interface of the printer is initialized (step 170). Configuration options and instructions corresponding to the configuration options are printed by the printer and user input is received via the input interface until either a printer configuration is selected and applied to the printer or a configuration error occurs (step 180).

During step 180, bidirectional communication between the server 32 and a user via the printing module 72 and input interface 80 of the printer is employed to present the user with and allow the user to select from a list of printer configuration options. The instructions specify interaction methods to be carried out by the user in order to select one of the printed options. As the input interface 80 of the printer only includes a feed button 88 and a cover 92, the interaction methods available are the depression/release of the feed button and the opening/closing of the cover. Upon receipt of user input, the input is analyzed and another set of options is presented, if deemed to be so required to obtain selection of a printer configuration. The set of options correspond to (a) existing printer configurations currently unused, (b) new printer configurations that can be used, or (c) the selection of (a) or (b). If inappropriate user input is received, the method 150 terminates after setting the printer to its factory default configuration.

If a printer configuration is selected, a confirmation message presenting the selected printer configuration and options for the confirmation or rejection of the selected printer configuration is printed. Instructions associated with the options permit user selection of one of the options via the input interface of the printer. If input corresponding to the confirmation option is received via the input interface, the printer is configured according to the selected printer configuration. If input corresponding to the rejection option is received via the input interface, printer configuration options are printed. If, instead, inappropriate input is received, the method 150 terminates after setting the printer to its factory default configuration.

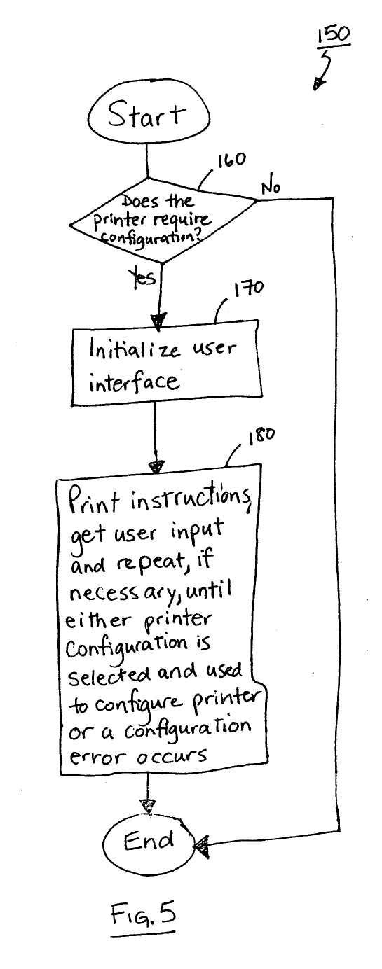

FIG. 6 illustrates the general method 200 of determining whether the printer may require configuration during step 160. The method 200 commences with the receipt of a response to the discovery probe message by the printer (step 210). The server 32 then determines whether the response was received within the last twelve seconds from a printer with this IP and MAC address combination (step 220). If the server 32 determines that a response was received from the same IP and MAC address combination in the last twelve seconds, the printer that generated the response is determined to not require configuration and the method ends (step 230). If, instead, the server 32 determines that a response was not received from the same IP and MAC address combination in the last twelve seconds, the printer that generated the response is deemed to require configuration and queued for configuration (step 240).

During the determination of whether the printer requires configuration at step 220, the server 32 compares the MAC and IP address to a response log maintained in RAM 68. The response log includes the MAC and IP addresses for printers that responded to the discovery probe messages and the time that each response was received. A connection-monitoring application executing on the server 32 processes the response log to determine which printers responded during the last twelve seconds. A twelve-second interval has been selected to allow for reasonable network and printer latencies. If a printer's MAC address and IP address appear in the response log together and are time-stamped as having responded within the last twelve seconds, the printer is assumed to be connected and, as a result, is deemed to not require configuration.

If the MAC address of the printer is not in the response log, the printer is deemed to be new to the communications network 36. If the response log indicates that the last response from the MAC address was more than twelve seconds ago, the printer is deemed to have been disconnected or reset. If the response log indicates that the last response from the printer's MAC address was received within the last twelve seconds, but using a different IP address, the printer is deemed to have been reconfigured, either by the server 32 or manually by a user. In all of these cases, it is determined by the server 32 that the printer may require configuration.

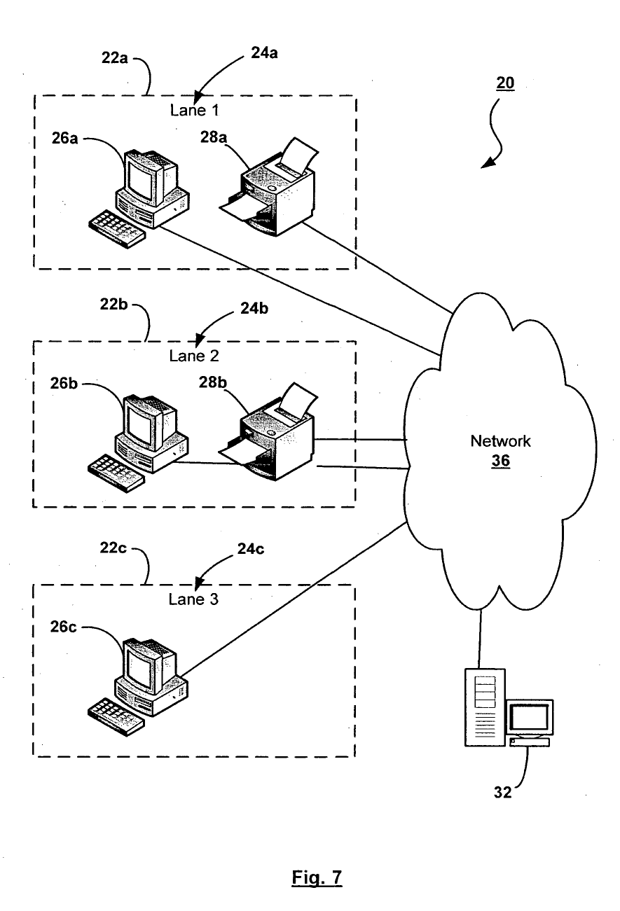

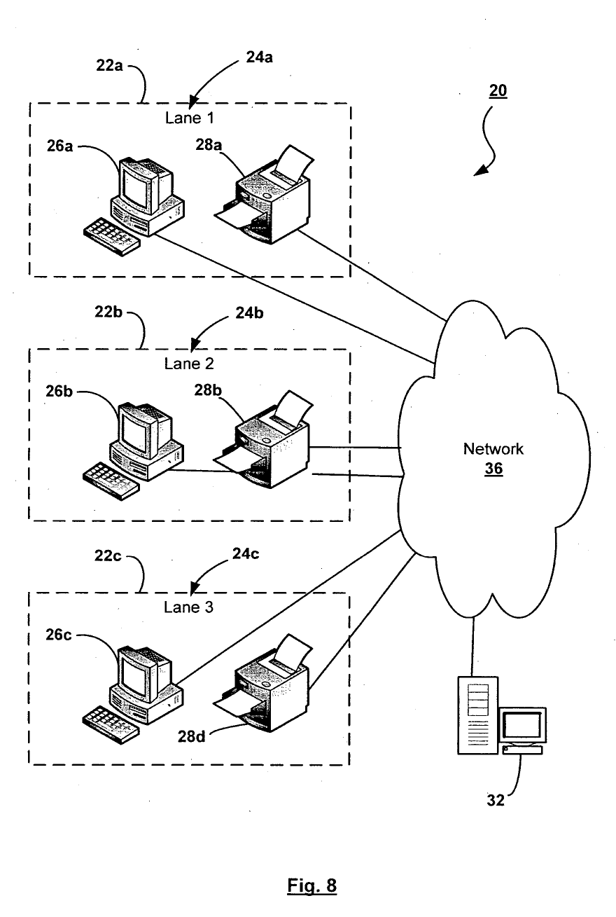

For illustration purposes, FIGS. 7 and 8 respectively show the system 20 after disconnection of the printer 28c at the station 22c from the communications network 36, and after connection of a replacement printer 28d. Upon powering up the printer 28d, it receives a discovery probe message broadcast by the server 32 and responds. Upon receipt of the response, the server 32 directs the connection-monitoring application to compare the MAC address of the printer 28d with the MAC addresses in the response log. The connection-monitoring application then determines that the printer 28d has not responded in the last twelve seconds and, as a result, the server 32 determines that the printer 28d may require configuration at step 220.

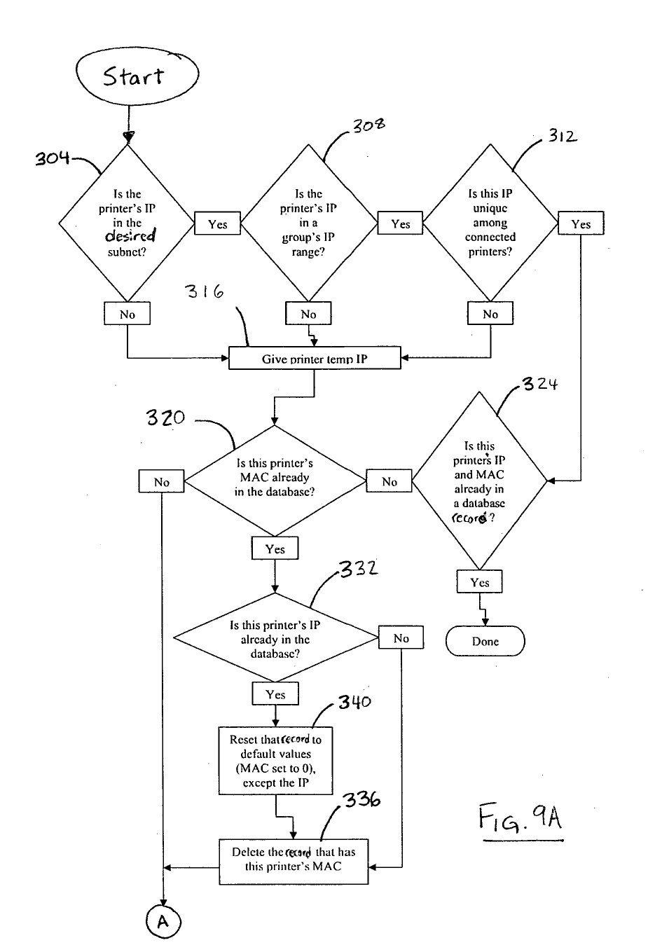

FIGS. 9A and 9B show the method of determining whether a printer identified as possibly requiring configuration actually requires configuration. In some instances, printers flagged as possibly requiring configuration may, in fact, be satisfactorily configured. That is, some printers may already have been previously configured by the server 32, but the MAC and IP address combinations have not been registered in the response log.

The method of determining whether a printer actually requires configuration begins with the determination by the server 32 of whether the printer's IP address is in the desired subnet, or IP address range (step 304). If the printer's IP address is in the desired subnet, the server 32 then determines whether the printer's IP address is in a pre-defined group's IP address range (step 308). Similar to DHCP, the server 32 is configured to have one or more ranges of IP addresses to which it can configure printers. Multiple groups can be defined and each group can have a range of IP addresses associated with it. If the printer's IP address is in a pre-defined group's IP address range, the server 32 determines whether the printer's IP address is unique among the connected printers (step 312). This is performed by comparing the printer's MAC and IP addresses to a list of connected printers generated from the response log.

If the server 32 determines that the printer's IP address is unique among connected printers at step 312, the server 32 determines whether the printer's IP address and MAC address are already together in a record in the printer station database (step 324). If the server 32 determines that the printer's IP address and MAC address are already together in a record in the printer station database at step 324, it is deemed that the printer was disconnected and then reconnected without configuration changes. As a result, the printer is able to use its previous configuration and the server 32 determines that configuration of the printer is not required. If the server 32 determines that the printer's IP address and MAC address are not together in a record in the printer station database at step 324, the server 32 determines whether the printer's MAC address is in the printer configuration database at step 320.

If the server 32 determines that the printer's MAC address is not in the printer configuration database at step 320, the server 32 determines whether the printer's IP address is in the printer configuration database (step 328). If the server 32 determines that the printer's MAC address is in the printer configuration database at step 320, the server 32 determines whether the printer's IP address is already in the printer configuration database (step 332). If the server 32 determines that the printer's IP address is not in the printer configuration database at step 332, the server 32 deletes the record in the printer configuration database having the printer's MAC address (step 336). If, alternatively, the server 32 determines that the printer's IP address is already in the printer configuration database at step 332, the server 32 resets all field entries in that record excluding the IP address to default values (step 340). After resetting the record at step 340, the server 32 deletes the record in the printer configuration database that has the printer's MAC address at step 336. Once the record in the printer configuration database having the printer's MAC address has been deleted at step 336, the server determines whether the printer's IP address is in the printer configuration database at step 328.

If the server 32 determines that the printer's IP address is in the printer configuration database at step 328, all field entries of that record are replaced with the printer's data (step 344), after which the method ends. In order to obtain the printer's data, the server 32 queries the printer via ESC/POS. The printer's data includes the model name, the model ID, the type ID, the firmware version, the SNMP trap settings, the status, the interface board type and the power status (if available).

If, instead, the server 32 determines that the printer's IP address is not in the printer configuration database at step 328, the server 32 determines whether the printer's IP address is in a valid group range (step 348). If the server 32 determines that the printer's IP address is in a valid group range at step 348, the printer is added to the printer configuration database with the printer's current IP address (step 352), after which the method ends. If, alternatively, the server 32 determines that the printer's IP address is not in a valid group range at step 348, the server 32 determines that user input is required and initiates a user interface initialization routine (step 356).

If the server 32 determines that the printer's IP address is not in the desired subnet at step 304 or in a pre-defined group's IP address range at step 308, or is not unique among connected printers at step 312, the server 32 assigns the printer a temporary IP address (step 316), after which the server 32 determines whether the printer's MAC address is in a printer configuration database (step 320). By configuring the printer with a valid and unique temporary IP address, instructions to be printed on the printer can be transmitted over TCP/IP.

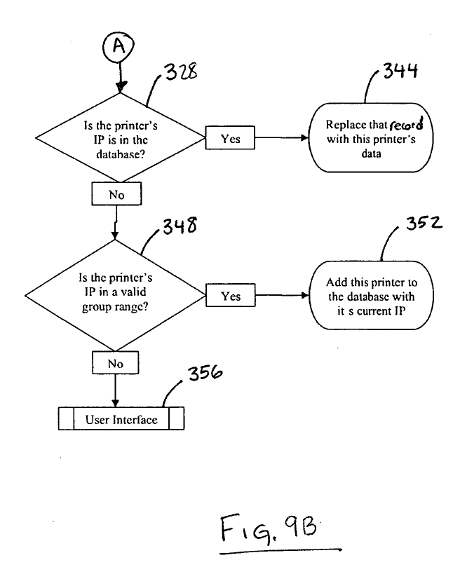

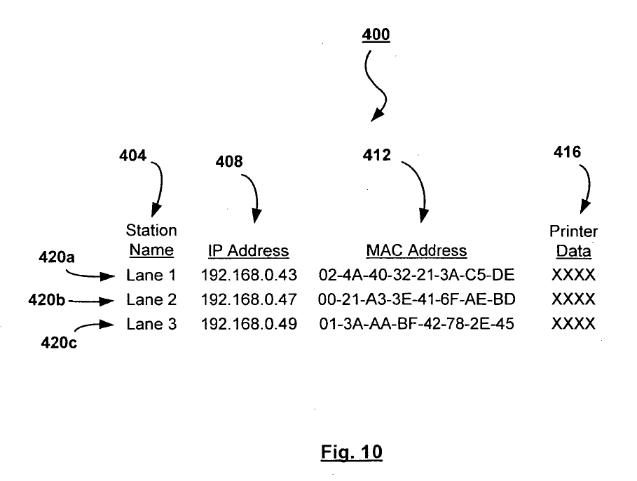

FIG. 10 shows the printer configuration database 400 maintained by the server 32. The printer configuration database 400 includes user-friendly names for the printer configurations employed by connected printers and printer configurations employed by printers previously connected to the network 36. The printer configuration database 400 is updated by the server 32 upon analysis and configuration (where required) of each printer to the discover messages. As shown, the printer configuration database 400 includes a user-friendly name field 404, an IP address field 408, a MAC address field 412 and one or more printer data fields 416.

The printer configuration database 400 contains a set of records 420a, 420b and 420c corresponding to individual printer configurations. Record 420a is identified as having the user-friendly name “Lane 1” corresponding to the station with which the printer configuration is associated and being assigned an IP address of 192.168.0.43. In addition, record 420a shows that the printer assigned to the station named “Lane 1” (i.e., printer 28a) has a MAC address of 02-4A-40-32-21-3A-C5-DE. Similarly, record 420b is identified as having the user-friendly name “Lane 2” corresponding to the station with which the printer configuration is associated and being assigned an IP address of 192.168.0.47. Record 420b also shows that the printer assigned to the station named “Lane 2” (i.e., printer 28b) has a MAC address of 00-21-A3-3E-41-6F-AE-BD. Also similarly, record 420c is identified as having the user-friendly name “Lane 3” corresponding to the station with which the printer configuration is associated and being assigned an IP address of 192.168.0.49. Record 420c also shows that the printer assigned to the station named “Lane 3” (i.e., printer 28c) has a MAC address of 01-3A-M-BF-42-78-2E-45.

The printer data fields 416 contain information about the printers such as, for example, the model name, the model ID, the type ID, the firmware version, the SNMP trap settings, the status, the interface board type and the power status.

FIG. 11 illustrates a user interface initialization routine performed by the POS system 20 once the server 32 determines that a printer requires configuration at step 356. During this routine, a header is printed to alert a user that printer configuration is commencing. The server 32 determines whether a user-defined introduction message is available (step 504). If available, the server 32 “dumps” the user-defined file containing the user-defined introductory message to the printer with a Double High Double Wide command as a header for printing (step 508). If a user-defined introduction message is not available, the server 32 transmits a default introductory message header to the printer for printing (step 512). Once the header has been printed, a replace routine is called (step 516).

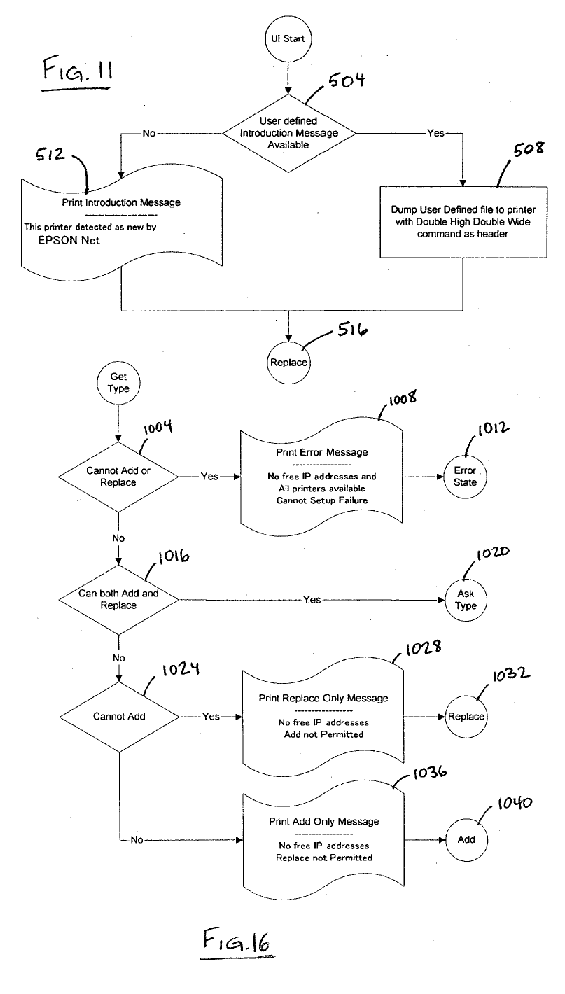

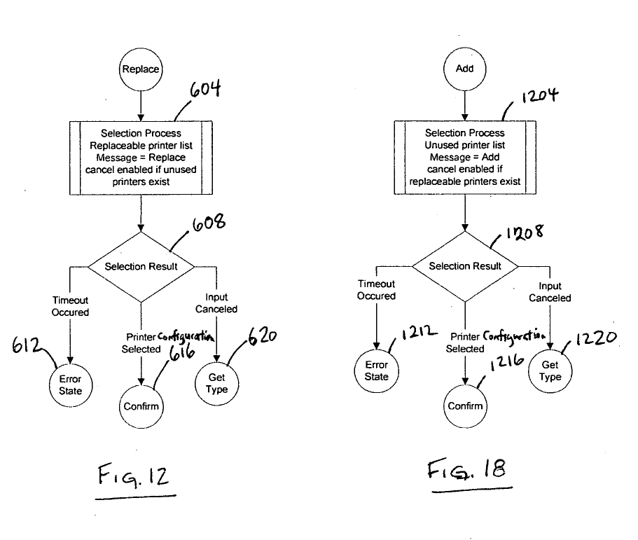

FIG. 12 illustrates the replace routine called at step 516. During this routine, a selection process routine is called for presenting a user with options for selecting a printer configuration used by the printer being replaced. A subsequent routine is then selected based on the result returned. The replace routine commences with the calling of the selection process routine (step 604). The selection process routine iteratively generates and prints options and receives input corresponding to the options until a single option is selected. The selection process routine is called with a parameter indicating that a cancel function is to be enabled if a printer can be added to the network with a new configuration. A selection result is received from the selection process routine (step 608). If the selection result indicates that a time-out occurred without receiving input, an error state routine is called (step 612). If, instead, a printer configuration was selected, a confirmation routine is called (step 616). Alternatively, if input was cancelled, a get type routine is called (step 620).

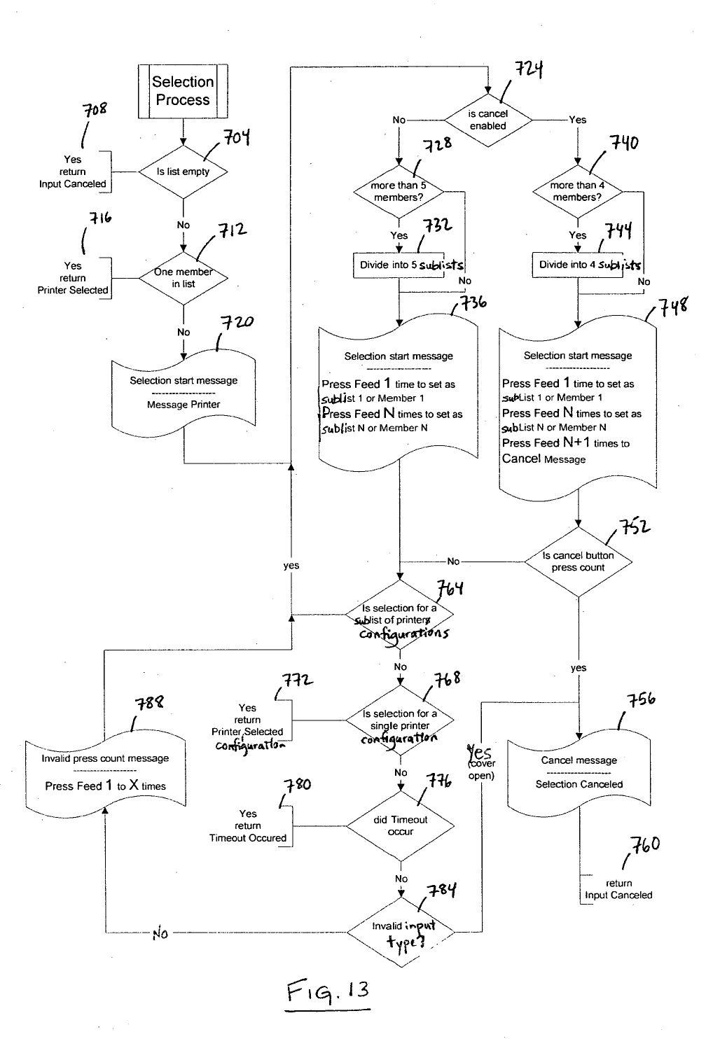

FIG. 13 illustrates the selection process routine called by the replace routine. The selection process routine generates and prints options, and allows selection of one of the options via user interaction with the input interface of the printer. This can be performed repeatedly until a printer configuration is selected. The selection process routine commences with the determination by the server 32 of whether the list of printer configurations corresponding to absent printers that may be replaced is empty (step 704). In order to generate the list of printer configurations corresponding to absent printers, the connection-monitoring application executing on the server 32 processes the response log and determines which printers appear to be connected by identifying the IP and MAC address pairs that responded during the last twelve seconds. The connection-monitoring application then compares this list to the printer configuration database to determine which printer configurations correspond to absent printers. If the list of printer configurations corresponding to absent printers is empty, the routine terminates and the result “input cancelled” is returned (step 708). If the list of printer configurations corresponding to absent printers is not empty, the server 32 determines whether there is only one printer configuration corresponding to an absent printer in the list (step 712). If there is only one absent printer in the list, the routine terminates and the result “printer configuration selected” is returned (716). If the server 32 determines that there are more than one printer configurations corresponding to absent printers at step 712, the server 32 messages the printer to print a selection start message (step 720). The selection start message either includes “Add printer” or “Replace printer” and is printed to notify the user of what is happening.

After messaging the printer, the server 32 determines if the cancel function is enabled (step 724). If the cancel function is not enabled, the server 32 determines if there are more than five members (i.e. printer configurations) in the list (step 728). If it is determined that there are more than five members, the members are divided into five sublists (step 732). The server 32 then directs the printer to print a set of options corresponding to the members, or sublists if applicable, and instructions for each option (step 736).

The print job for the options and instructions is communicated using the ESC/POS protocol via TCP/IP port 9100. The instructions for each option direct the user to press the feed button of the input interface of the printer a specified number of times to select a specific member, or sublist if there are more than five members. By dividing the list of members into sublists where there are more than five, the number of options presented to a user is limited to five and, thus, the number of times that the feed button must be pressed to select an option is limited to five.

If it is determined at step 724 that cancel is enabled, the server 32 determines if there are more than four members (step 740). If there are more than four members, the members are divided into four sublists (step 744). The server 32 then directs the printer to print a set of options and instructions for each option (step 748). In this case, the set of options corresponds to the members, or sublists if applicable, plus a cancel option. The instructions for each option direct the user to press the feed button of the input interface of the printer a specified number of times to select a specific member, or sublist if there are more than four members, or to cancel the configuration of the printer. As noted above, the set of options is restricted to five in order to limit the number of times that the feed button must be pressed.

After both of steps 736 and 748, the server 32 listens to determine what input is received. When a user presses the feed button, the printer transmits a message to the server 32 corresponding to the interaction method performed (i.e. the depression of the feed button). The server 32 listens for messages until either a time-out period of thirty seconds have passed without receiving a first message, a time-out period of two seconds has passed without receiving further messages, or it is determined that the messages received do not correspond to the instructions for any of the options.

Where cancel is enabled, after step 748, the server 32 determines whether the number of presses of the feed button correspond to the instructions for the cancel option. If the server 32 determines that the messages correspond to the cancel option, the server 32 directs the printer to print a cancel message, indicating that the printer configuration has been cancelled (step 756), after which the routine returns the result “input cancelled” (step 760).

If, instead, the server 32 determines that the messages do not correspond to the cancel option, or if no cancel option was available (such as at step 736), the server 32 determines whether the messages correspond to an option for a sublist (step 764).

If the messages correspond to a sublist, the routine returns to step 724, such that a member (i.e. printer configuration) of the sublist may be selected. In this case, the sublist is used in place of the list during the performance of the next few steps. Where there are a large number of members in the list, this process can be repeated to “drill down” to a specific printer configuration.

If, instead, the server 32 determines that the messages do not correspond to a sublist of printer configurations at step 764, the server 32 determines whether the number of presses of the feed button correspond to a specific printer configuration (step 768). If the server 32 determines that the number of presses of the feed button corresponds to a specific printer configuration, the routine terminates and returns “printer configuration selected” (step 772). If the server determines that the number of presses of the feed button do not correspond to a specific printer configuration at step 768, the server 32 determines whether a time-out occurred before the feed button was pressed (step 776). If no feed button presses were received before the time-out, the routine ends and returns “time-out occurred” (step 780). If the server 32 determines that feed button presses were received before a time-out occurred, the server 32 determines whether an invalid input type was received. (step 784). Invalid input for a printer includes the opening of the cover 92. If invalid input is received, a cancel message is printed at step 756 and the message that input was cancelled is returned at step 760. If, instead, no invalid input types were received, it is determined that the number of feed button presses is invalid and the server 32 directs the printer to print an error message (step 788). The error message indicates what input is acceptable; that is, the number of times that the feed button may be pressed to validly indicate selection of an option. The routine then returns to step 724 to thereafter regenerate a list of printer configurations or sublists from which a user is to select.

FIG. 14 shows the error state routine called upon detection of an error state, such as during step 612 of the replace routine. During the replace routine, if the selection process routine returns “time-out occurred”, the error state routine is called. The error state routine commences with the server 32 directing the printer to print an error message corresponding to the nature of the error (step 804). The server 32 then directs the printer to reset its IP address to the factory default (step 808), ending the routine.

If, during the replace routine, the selection process routine returns “printer configuration selected”, indicating that a printer configuration was validly selected from the list of printers, confirmation is sought at step 616. The user is presented with the user-friendly name of the selected printer configuration and asked to confirm the selection.

FIG. 15 shows the confirmation routine used to confirm the selected printer configuration selection. The routine commences with the server 32 directing the printer to print a confirmation request (step 904). The confirmation request includes details of the user-friendly name of the selected printer configuration and the network configuration associated with the user-friendly name. The network configuration includes the IP address, the subnet mask and the IP gateway. The confirmation request also includes instructions corresponding to the confirmation or rejection of the selected printer configuration. In particular, the confirmation request specifies that the feed button should be pressed once to confirm the selected printer configuration, and twice to reject the selected printer configuration. The server 32 then listens to receive messages corresponding to feed button press input (step 908). The server 32 listens for feed button presses until either a time-out period of thirty seconds has passed without detecting a feed button press, a time-out period of two seconds has passed without detecting further feed button presses, or it is determined that the messages received do not correspond to the instructions for any of the options.

If two presses of the feed button are detected at step 908, indicating a rejection of the selected printer configuration, the get type routine is called (step 912). If a time-out has occurred without detecting any presses of the feed button at step 908, the error state routine is called (step 916). If only one press of the feed button is detected at step 908, the server 32 directs the printer to assume the selected printer configuration, reads the printer information, and saves the printer information in the printer configuration database (step 920). Next, the server 32 directs the printer to print a success message, indicating that the printer has been successfully configured (step 924), after which the confirmation routine terminates. If an unexpected number of feed button presses is detected at step 908 (i.e. more than two), the server 32 directs the printer to print a warning message indicating the acceptable number of presses of the feed button (step 928), after which the confirmation routine is repeated (step 932).

Where a printer is to be added to the POS system 20 with a new configuration, the user cancels the replacement routine by canceling the selection of a printer configuration which the new printer is to assume.

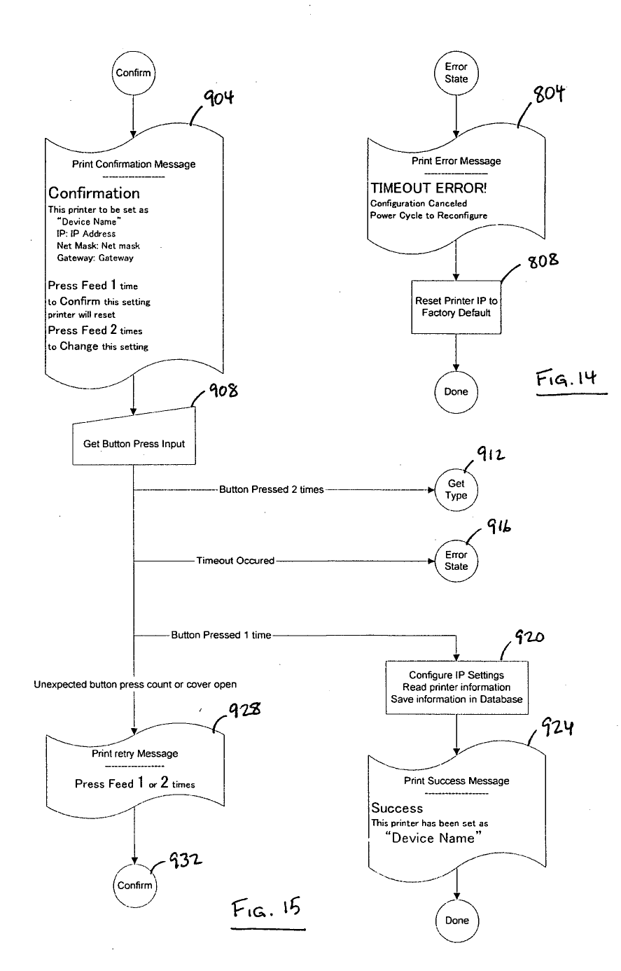

FIG. 16 shows the get type routine that allows a user to select whether the printer is to replace a removed printer by assuming its configuration or is to be added with a new printer configuration. The routine commences with the server 32 determining whether the printer can replace an absent printer or can be added with a new configuration (step 1004). If there are no absent printers, no currently existing configurations can be applied to the newly added printer. In addition, if no unassigned IP addresses are available in the subnet's and group's IP range, a printer cannot be added with a new configuration.

If it is determined at step 1004 that a printer cannot be added or cannot replace an absent printer, the server 32 directs the printer to print an error message (step 1008), after which the error state routine is called (step 1012). If, instead, it is determined at step 1004 that the printer can either be added or replace an absent printer, the server 32 determines whether the printer can both be added and replace an absent printer (step 1016). If it is determined that the printer can both be added and replace an absent printer, an ask type routine is called (step 1020). If it is determined that the printer cannot both be added or replace an absent printer, the server 32 determines whether the printer can be added with a new configuration (step 1024). If the printer cannot be added with a new configuration, the server 32 directs the printer to print an information message (step 1028). After printing the information message at step 1028, the replace routine is called (step 1032). If the printer can be added to the network 36 with a new configuration, the server 32 directs the printer to print an information message (step 1036). The information message indicates that the printer can only be added to the network 36 with a new configuration. After printing the information message at step 1036, the add routine is called (step 1040).

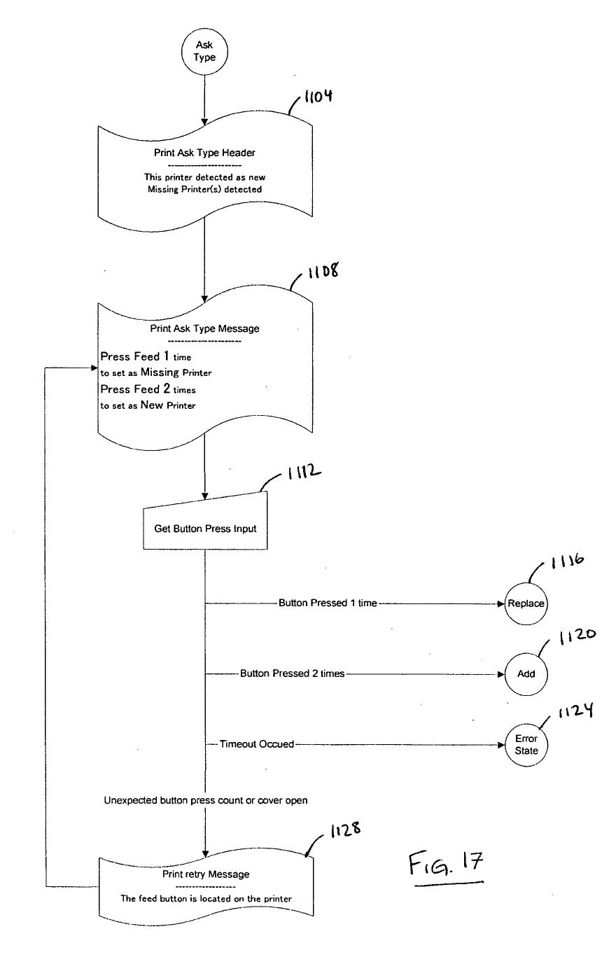

FIG. 17 shows the ask type routine. The ask type routine allows a user to select whether the printer is to be added to the network 36 with a new configuration or replace an absent/missing printer by assuming its configuration. The routine commences with the server 32 directing the printer to print an ask type header (step 1104). The ask type header indicates whether the printer just recently attached to the network is new and whether there are absent printers. The server 32 then directs the printer to print an ask type message (step 1108). The ask type message presents the user with the options to replace an absent printer and to add the printer to the network with a new configuration. Instructions are presented for each option. Specifically, it is noted that the feed button is to be pressed once to replace an absent printer by assuming its configuration, and twice to add the printer to the network with a new configuration.

The server 32 then listens for feed button press input (step 1112). The server 32 waits for feed button presses until either a time-out period of thirty seconds has passed without detecting a feed button press, a time-out period of two seconds has passed without detecting further feed button presses, or it is determined that the number of feed button presses received do not correspond to the instructions for any of the options.

If only one button press is detected, the replace routine is called (step 1116). If two button presses are detected, the add routine is called (step 1120). If a time-out occurs without the detection of button presses, the error state routine is called (step 1124). If an unexpected number of button presses is detected or the printer cover is opened, the server 32 directs the printer to print a print retry message (step 1128). The print retry message indicates the location of the feed button on the printer to assist the user. After printing the print retry message, the routine returns to step 1108, where the ask type message is reprinted.

FIG. 18 illustrates the add routine that is called when a printer can only be connected to the network using a new configuration (i.e. from step 1040) or when the user selects to add the printer at step 1120. During this routine, the selection process routine is called for presenting a user with options for selecting a printer configuration not previously used and a subsequent routine is selected based on the result returned. The add routine commences with the calling of the selection process routine (step 1204). The selection process routine is called with the parameter indicating that the cancel function is to be enabled if absent printers can be replaced by a printer. A selection result is received from the selection process routine (step 1208). If the selection result indicates that a time-out occurred without receiving input, an error state routine is called (step 1212). If, instead, a printer configuration was selected, a confirmation routine is called (step 1216). Alternatively, if input was cancelled, a get type routine is called (step 1220).

During execution of the selection process routine, configuration names are generated at step 704 using a naming convention defined by the group in which the IP address resides. For example, the fourth IP address in a group with the naming convention “Lane” would be called “Lane 4”.

As will be appreciated, by using bidirectional communication via the printing module and the input interface of the printer, the printer can be configured directly without the need for direct user interaction with a computer. Further, as user-friendly names associated with the printer configurations are used, users who are not technically adept at network configuration can readily configure the printer.

While specificity to the network configuration of a printer has been made, those of skill in the art will appreciate that other types of configuration can be performed. For example, various other printer settings can be configured, such as the printing of banner pages with jobs, the turning on or off of various network interfaces of the printer (such as an infrared port), etc.

The input interface can include, for example, other buttons, switches, covers and paper trays, or any combination thereof. The covers can include the toner cartridge cover and various paper path doors. The printers can detect and register the depression of the various buttons, the switching of the switches, the opening and closing of the covers and the withdrawal and reinsertion of the paper trays. The number of interaction methods generally increases with the number of features of the input interface. Further, the instructions can specify that the buttons are to be pressed for brief or longer periods of time, with a certain frequency, etc. This further increases the number of interaction methods available to compose instructions. By increasing the number of interaction methods, the number of options with different instructions can be increased without increasing the number interaction methods that need to be performed to select a single option. Other input interfaces and interaction methods will occur to those skilled in the art.

The server can query the printers to determine what model each is and, thus, what interaction methods are available. The server can maintain or have access to a list of models and the various interaction methods available for each.

Where there is a large number of printer configurations available as options, it can be desirable to present the user with the entire list of printer configurations or large sections thereof. In such cases, input can be facilitated using a number of interaction methods where available.

While configuration settings have been maintained for stations at which printers are located in the described embodiment, various systems for maintaining configuration settings can be utilized with the present invention. For example, where printers installed in a system can be configured in accordance with one of a set of configurations comprising a number of settings, and where two or more printers can be configured in accordance with a single configuration, it can be advantageous to establish the configurations with user-friendly names on a server, and allow selection of a particular configuration presented in a set of printed configuration options using the printer's input interface. In this manner, a user can avoid individually configuring a number of settings corresponding to a particular configuration.

While specificity has been made to a particular type of network, those of skill in the art will readily understand that the configuration method can be used with various other types of networks.

It can be desirable to present a user with a number of possible names for new printer configurations. For example, the current or last group of printer configurations can be analyzed to determine if there is a pattern to printer configuration naming. The determined naming convention can then be presented to the user along with other names generated using any other pre-determined naming convention to create new printer configurations.

It can be desirable to permit configuration of a printer where the printer generates and prints a list of options and corresponding instructions without the use of a server. For example, two or more initial configurations can be pre-determined for a printer that can then be selected from by a user via the input interface. Such configurations can include, for example, “home user”, “small office user”, etc. In this manner, a group of settings can be configured by the selection of one option in order to reduce the configuration of individual settings of the printer.

It may be advantageous to include additional information on the printed page(s) of instructions to assist a user in selecting an option and following the instructions. The additional information can further clarify the options for the user. For example, the additional information can be a text string intended to supplement the user-friendly name, such as landmarks proximal to the station, height of the station, GPS location, etc. Further, the additional information can further explain the instructions. For example, pictures of the interaction methods can be supplied to provide the user with a visual aid.

Although embodiments have been described, those of skill in the art will appreciate that the variations and modifications may be made without departing from the spirit and scope thereof as defined by the appended claims.

1. A method for configuring a printer, comprising:
printing instructions on a printer;
receiving input based on the printed instructions via an input interface of said printer; and
configuring said printer using said input.

2. The method of claim 1, wherein said printer is connected to a network.

3. The method of claim 2, wherein said configuring comprises:
configuring at least one network setting of said printer.

4. The method of claim 3, further comprising:
determining whether said printer requires configuration before said printing.

5. The method of claim 2, further comprising:
discovering said printer on said network.

6. The method of claim 5, wherein said discovering comprises:
receiving with said printer a discovery probe message from said computing device; and
responding with said printer to said discovery probe message.

7. The method of claim 4, further comprising:
configuring said printer with at least one initial network setting.

8. The method of claim 7, wherein said at least one initial network setting includes an initial IP address.

9. The method of claim 7, wherein said configuring comprises:
transmitting said input to a computing device; and
receiving configuration information from said computing device in response to said input.

10. The method of claim 9, wherein said configuration information includes at least one network setting.

11. The method of claim 10, wherein said configuration information includes an IP address.

12. The method of claim 1, wherein said instructions correspond to a set of options.

13. The method of claim 12, said options are identified using user-friendly names.

14. The method of claim 13, wherein said options correspond to network configurations.

15. The method of claim 14, wherein each of said network configurations comprises an IP address.

16. The method of claim 15, wherein said options correspond to stations.

17. The method of claim 14, wherein at least one of said network configurations corresponds to an absent printer.

18. The method of claim 14, wherein at least one of said network configurations is unassociated with both absent and connected printers.

19. The method of claim 1, wherein said instructions direct the pressing of a feed button.

20. The method of claim 1, wherein said instructions direct the opening of a cover of said printer.

21. The method of claim 1, wherein said instructions direct a sequence of interaction methods.

22. The method of claim 1, wherein said configuring is selectively performed when said input corresponds to said instructions.

23. A method for configuring a printer using a computing device, comprising:
transmitting instructions to be printed to a printer;
detecting input entered via said printer, said input corresponding to said instructions and being received by said printer via an input interface thereof; and
transmitting configuration information to said printer in accordance with the detected input.

24. A printer, comprising:
a network interface detecting and establishing communication with a computing device, and receiving instructions associated with a set of options to be printed from said computing device;
a printing module printing said instructions;
an input interface receiving input corresponding to said instructions; and
a processor directing said input to said network interface for transmission to said computing device, and configuring said printing data in response to configuration information received from said computing device.

25. The printer of claim 24, wherein said configuration information is network configuration information.

26. The printer of claim 25, wherein said processor configures network settings of said printer in accordance with said network configuration information.

27. The printer of claim 24, wherein said input interface comprises a feed button.

28. A method of enabling communication with a computing device using a printer, comprising:
receiving instructions from a computing device with a printer;
printing said instructions with said printer;
receiving input corresponding to said instructions via an input interface of said printer; and
transmitting said input to said computing device.

29. A printer, comprising:
a network interface receiving, from a computing device, at least one instruction to be printed;
a printing module printing said at least one instruction; and
an input interface receiving input corresponding to said at least one instruction, wherein said input is transmitted to said computing device via said network interface.

30. The printer of claim 29, wherein said network interface receives configuration information from said computing device in response to said transmitted input, and wherein said printer further comprises:
a processor executing a configuration program for configuring settings of said printer in accordance with said configuration information.

31. The printer of claim 30, wherein said configuration information is network configuration information and wherein said configuration program configures network settings of said printer in accordance with said network configuration information.

32. The printer of claim 29, wherein said input interface comprises a feed button.
